(19) United States
(12) Patent Application Publication
(10) Pub. No.: US 2016/0063922 A1
(43) Pub. Date: Mar. 3, 2016

(54) Organic Light-Emitting Diode Display

(71) Applicant: Apple Inc., Cupertino, CA (US)

(72) Inventors: Tsung-Ting Tsai, Taipei (TW); Vasudha Gupta, Cupertino, CA (US); Chin-Wei Lin, Cupertino, CA (US); Shih-Chang Chang, Cupertino, CA (US); Young Bae Park, San Jose, CA (US)

(21) Appl. No.: 14/490,564

(22) Filed: Sep. 18, 2014

Related U.S. Application Data
(63) Continuation-in-part of application No. 14/469,513, filed on Aug. 26, 2014.

(51) Int. Cl. G09G 3/32

(52) U.S. Cl. CPC G09G 3/3258; G09G 2320/0252; G09G 2310/061

(57) ABSTRACT

A display may have an array of organic light-emitting diode display pixels. Each display pixel may have a light-emitting diode that emits light under control of a drive transistor. Each display pixel may also have control transistors for compensation and programming operations. Each display pixel may have six thin-film transistors and one capacitor. One of the six transistors may serve as the drive transistor and may be compensated using the remaining five transistors and the capacitor. The capacitor may have a first terminal coupled to the gate of the drive transistor and a second terminal coupled to the light-emitting diode. In one embodiment, two scan control signals and two emission control signals may be used for each row of display pixels. In another embodiment, a single scan control signal and a single emission control signal may be formed for each row of display pixels.

This application is a continuation-in-part of patent application Ser. No. 14/469,513, filed Aug. 26, 2014, which is hereby incorporated by reference herein in its entirety. This application claims the benefit of and claims priority to patent application Ser. No. 14/469,513, filed Aug. 26, 2014.

### BACKGROUND

This relates generally to electronic devices with displays and, more particularly, to display driver circuitry for displays such as organic-light-emitting diode displays.

Electronic devices often include displays. For example, cellular telephones and portable computers include displays for presenting information to users.

Displays such as organic light-emitting diode displays have an array of display pixels based on light-emitting diodes. In this type of display, each display pixel includes a light-emitting diode and thin-film transistors for controlling application of a signal to the light-emitting diode to produce light.

Threshold voltage variations in the thin-film transistors can cause undesired visible display artifacts. For example, threshold voltage hysteresis can cause white pixels to be displayed differently depending on context. The white pixels in a frame may, as an example, be displayed accurately if they were preceded by a frame of white pixels, but may be displayed inaccurately (i.e., they may have a gray appearance) if they were preceded by a frame of black pixels. This type of history-dependent behavior of the light output of the display pixels in a display causes the display to exhibit a low response time. To address the issues associated with threshold voltage variations, displays such as organic light-emitting diode displays are provided with threshold voltage compensation circuitry. Such circuitry may not, however, adequately address all threshold voltage variations, may not satisfactorily improve response times, and may have a design that is difficult to implement.

It would therefore be desirable to be able to provide a display with improved threshold voltage compensation circuitry.

### SUMMARY

An electronic device may include a display having an array of display pixels. The display pixels may be organic light-emitting diode display pixels. Each display pixel may have an organic light-emitting diode that emits light and a drive transistor that controls the application of current to the organic light-emitting diode. The drive transistor has an associated threshold voltage.

Each display pixel may have control transistors for threshold voltage compensation and diode capacitance compensation operations. During compensation operations, the control transistors are controlled so as to compensate the drive transistor for variations in the threshold voltage of the drive transistor and to compensate for variations in the parasitic capacitance associated with the organic light-emitting diode. This ensures that the output of the light-emitting diode will be responsive to the size of the data signal loaded into the display pixel and independent of threshold voltage and its capacitance.

With one arrangement, each display pixel has six n-type transistor and a single capacitor. One of the six n-type transistors serves as the drive transistor for the display pixel and may be compensated using the remaining five of the n-type transistors and the capacitor. In this arrangement, each row of display pixels may be controlled using two scan control lines and two emission control lines. With another arrangement, each row of row of display pixel may be controlled using only one scan control line, one emission control line associated with that row, and another emission control line routed from an immediately preceding row.

### BRIEF DESCRIPTION OF THE DRAWINGS

FIG. 1 is a diagram of an illustrative display such as an organic light-emitting diode display having an array of organic light-emitting diode display pixels in accordance with an embodiment.

FIG. 2 is a circuit diagram of an image pixel array and associated driver circuitry in accordance with an embodiment of the present invention.

FIG. 3 is a diagram of an illustrative organic light-emitting diode display pixel of the type that may be used in a display in accordance with an embodiment.

FIG. 4 is a timing diagram showing signals involved in operating the display pixel circuitry of FIG. 3 in accordance with an embodiment.

FIG. 5 is a diagram of an illustrative organic light-emitting diode display pixel of the type shown in FIG. 3 with a reduced number of control lines in accordance with an embodiment.

FIG. 6 is a timing diagram showing signals involved in operating the display pixel circuitry of FIG. 5 in accordance with an embodiment.

FIG. 7 is a timing diagram showing an illustrative control scheme with serial data loading that may be used in controlling a display with pixel circuits of the type shown in FIG. 3 in accordance with an embodiment.

FIG. 8 is a timing diagram showing an illustrative control scheme with parallel data loading that may be used in controlling a display with pixel circuits of the type shown in FIG. 3 in accordance with an embodiment.

### DETAILED DESCRIPTION

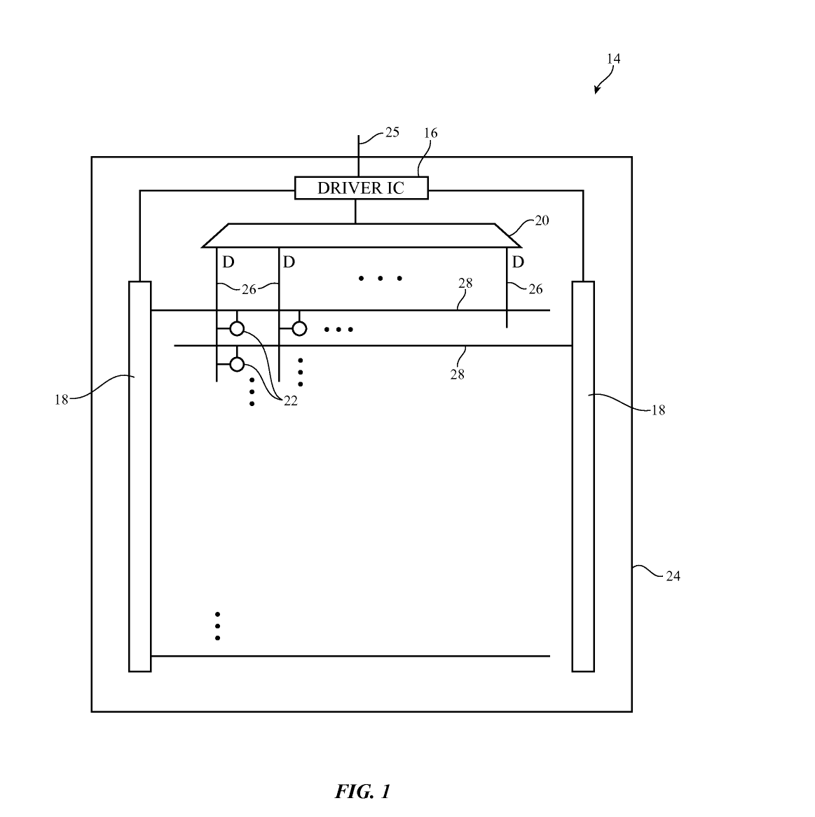

A display in an electronic device may be provided with driver circuitry for displaying images on an array of display pixels. An illustrative display is shown in FIG. 1. As shown in FIG. 1, display 14 may have one or more layers such as substrate 24. Layers such as substrate 24 may be formed from planar rectangular layers of material such as planar glass layers. Display 14 may have an array of display pixels 22 for displaying images for a user. The array of display pixels 22 may be formed from rows and columns of display pixel structures on substrate 24. These structures may include thin-film transistors such as polysilicon thin-film transistors, semiconducting oxide thin-film transistors, etc. There may be any suitable number of rows and columns in the array of display pixels 22 (e.g., ten or more, one hundred or more, or one thousand or more).

Display driver circuitry such as display driver integrated circuit 16 may be coupled to conductive paths such as metal traces on substrate 24 using solder or conductive adhesive. Display driver integrated circuit 16 (sometimes referred to as a timing controller chip) may contain communications circuitry for communicating with system control circuitry over path 25. Path 25 may be formed from traces on a flexible printed circuit or other cable. The system control circuitry may be located on a main logic board in an electronic device such as a cellular telephone, computer, television, set-top box, media player, portable electronic device, or other electronic equipment in which display 14 is being used. During operation, the system control circuitry may supply display driver integrated circuit 16 with information on images to be displayed on display 14 via path 25. To display the images on display pixels 22, display driver integrated circuit 16 may supply clock signals and other control signals to display driver circuitry such as row driver circuitry 18 and column driver circuitry 20. Row driver circuitry 18 and/or column driver circuitry 20 may be formed from one or more integrated circuits and/or one or more thin-film transistor circuits on substrate 24.

Row driver circuitry 18 may be located on the left and right edges of display 14, on only a single edge of display 14, or elsewhere in display 14. During operation, row driver circuitry 18 may provide row control signals on horizontal lines 28 (sometimes referred to as row lines or “scan” lines). Row driver circuitry 18 may therefore sometimes be referred to as scan line driver circuitry. Row driver circuitry 18 may also be used to provide other row control signals, if desired.

Column driver circuitry 20 may be used to provide data signals D from display driver integrated circuit 16 onto a plurality of corresponding vertical lines 26. Column driver circuitry 20 may sometimes be referred to as data line driver circuitry or source driver circuitry. Vertical lines 26 are sometimes referred to as data lines. During compensation operations, column driver circuitry 20 may use paths such as vertical lines 26 to supply a reference voltage. During programming operations, display data is loaded into display pixels 22 using lines 26.

Each data line 26 is associated with a respective column of display pixels 22. Sets of horizontal signal lines 28 run horizontally through display 14. Power supply paths and other lines may also supply signals to pixels 22. Each set of horizontal signal lines 28 is associated with a respective row of display pixels 22. The number of horizontal signal lines in each row may be determined by the number of transistors in the display pixels 22 that are being controlled independently by the horizontal signal lines. Display pixels of different configurations may be operated by different numbers of control lines, data lines, power supply lines, etc.

Row driver circuitry 18 may assert control signals on the row lines 28 in display 14. For example, driver circuitry 18 may receive clock signals and other control signals from display driver integrated circuit 16 and may, in response to the received signals, assert control signals in each row of display pixels 22. Rows of display pixels 22 may be processed in sequence, with processing for each frame of image data starting at the top of the array of display pixels and ending at the bottom of the array (as an example). While the scan lines in a row are being asserted, the control signals and data signals that are provided to column driver circuitry 20 by circuitry 16 direct circuitry 20 to demultiplex and drive associated data signals D onto data lines 26 so that the display pixels in the row will be programmed with the display data appearing on the data lines D. The display pixels can then display the loaded display data.

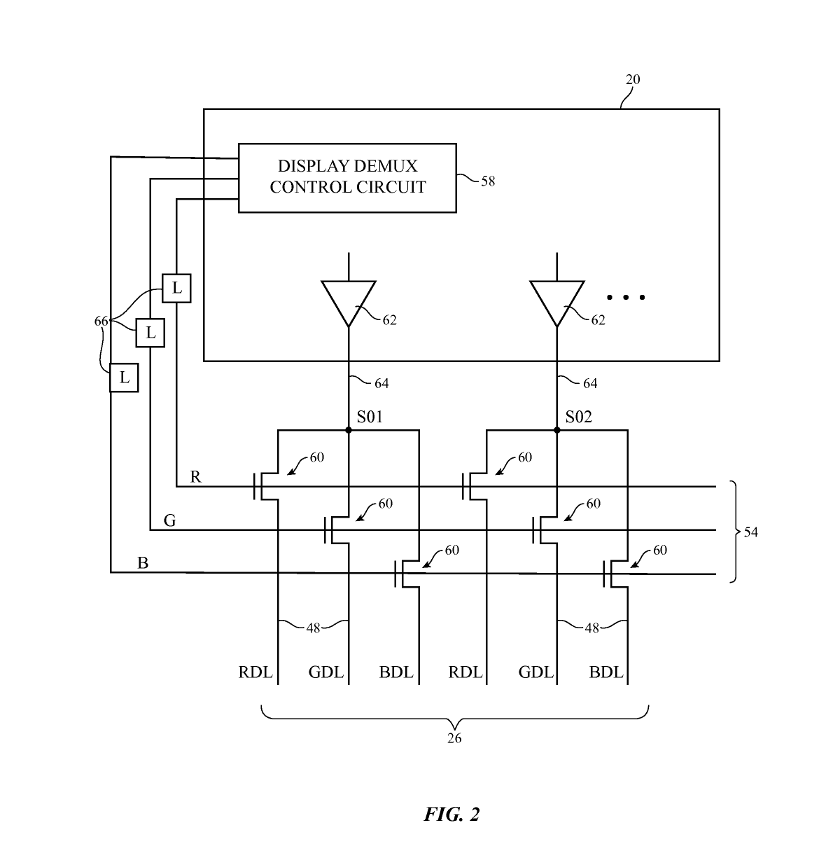

Column driver circuitry 20 may output data line signals that contain grayscale information for multiple color channels, such as red, green, and blue channels. Demultiplexing circuitry 54 may demultiplex this data line signal into respective R, G, and B data line signals on respective data lines 48. As shown in the example of FIG. 2, a display demultiplexer control circuit such as display demultiplexer control circuit 58 in column circuitry 20 may be used to supply data line demultiplexer control signals R, G, and B (corresponding to red, green, and blue channels in this example) to the gate terminals of demultiplexing transistors 60. Data line drivers 62 may produce data line output signals SO1, SO2, . . . (sometimes referred to as source output signals) on data line paths 64. The source output signals contain analog pixel data for image pixels of all three colors (i.e., red, blue, and green). The control signals that are applied to the gates of demultiplexing transistors 60 turn transistors 60 on and off in a pattern that routes red channel information from the source output signals to red data lines RDL, that routes green channel information from the source output signals to green data lines GDL, and that routes blue channel information from the source output signals to blue data lines BDL.

Optional loading circuits 66 may be implemented using one or more discrete components (e.g., capacitors, inductors, and resistors) that are interposed within lines 54 or may be implemented in a distributed fashion using some or all of the structures that form lines 54. Optional loading circuits 66 and/or circuitry in column driver circuitry 20 (e.g., circuit 58) may be used to control the shape of the demultiplexing control signals R, G, and B. Signal shaping techniques such as these may be used to smooth display control signal pulses such as the demultiplexer control signal pulses and thereby reduce harmonic signal production and radio-frequency interference.

In an organic light-emitting diode display such as display 14, each display pixel contains a respective organic light-emitting diode for emitting light. A drive transistor controls the amount of light output from the organic light-emitting diode. Control circuitry in the display pixel is configured to perform threshold voltage compensation operations so that the strength of the output signal from the organic light-emitting diode is proportional to the size of the data signal loaded into the display pixel while being independent of the threshold voltage of the drive transistor.

The current state of the art display pixel having threshold voltage compensation capabilities includes four thin-film transistors and an organic light-emitting diode having an associated capacitance C_{OLED}. The four transistors are controlled by two scan control signals and a single emission control signal. The resulting output signal produced by this type of display pixel may be independent of the threshold voltage of the drive transistor but may still be sensitive to the capacitance C_{OLED} of the light-emitting diode, which can cause the brightness of the display to vary over time. Other issues associated with such type of display pixels include reduced maximum brightness of the display, high power consumption, and lateral leakage between neighboring pixels. It may therefore be desirable to provide improved display pixels that address these issues.

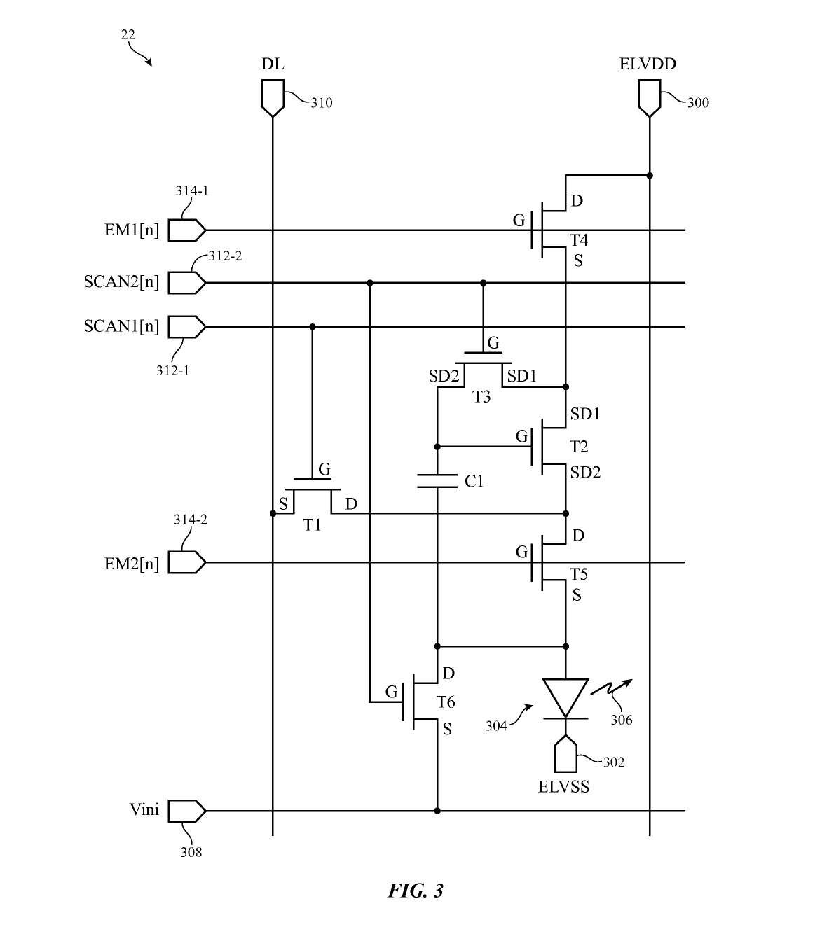

A schematic diagram of an illustrative organic light-emitting diode display pixel 22 in display 14 in accordance with an embodiment of the present invention is shown in FIG. 3. Display pixel 22 of FIG. 3 has a storage capacitor C1 and transistors such as n-type (i.e., re-channel) transistors T1, T2, T2, T3, T4, T5, and T6. The transistors of pixel 22 may be thin-film transistors formed from a semiconductor such as polysilicon, indium gallium zinc oxide (IGZO), etc. If desired, any one or more of transistors T1-T6 may be p-type (i.e., p-channel) thin-film transistors.

As shown in FIG. 3, display pixel 22 may include light-emitting diode 304. A positive power supply voltage ELVDD may be supplied to positive power supply terminal 300 and a ground power supply voltage ELVSS (e.g., 0 volts or other suitable voltage) may be supplied to ground power supply terminal 302. The state of drive transistor T2 controls the amount of current flowing from terminal 300 to terminal 302 through diode 304 and therefore the amount of emitted light 306 from display pixel 22. Diode 304 may have an associated parasitic capacitance C_{OLED} (not shown).

Terminal 308 is used to supply an initialization voltage Vini (e.g., a negative voltage such as −1 V or −2 V or other suitable voltage) to assist in turning off diode 304 when diode 304 is not in use. Control signals from display driver circuitry such as row driver circuitry 18 of FIG. 1 are supplied to control terminals such as terminals 312-1, 312-2, 314-1, and 314-2. Terminals 312-1 and 312-2 may serve respectively as first and second scan control terminals, whereas terminals 314-1 and 314-2 may serve respectively as first and second emission control terminals. Scan control signals SCAN1 and SCAN2 may be applied to scan terminals 312-1 and 312-2, respectively. Emission control signals EM1 and EM2 may be supplied to terminals 314-1 and 314-2, respectively. A data input terminal such as data signal terminal 310 is coupled to a respective data line 26 of FIG. 1 for receiving image data for display pixel 22.

In the example of FIG. 3, transistors T4, T2, T5, and diode 304 may be coupled in series between power supply terminals 300 and 302. In particular, transistor T4 may have a drain terminal that is coupled to positive power supply terminal 300, a gate terminal that receives first emission control signal EM1, and a source terminal. The terms “source” and “drain” terminals of a transistor can sometimes be used interchangeably and may therefore be referred to herein as “source-drain” terminals. Drive transistor T2 may have a first source-drain terminal SD1 that is coupled to the source terminal of transistor T4, a gate terminal, and a second source-drain terminal SD2. Transistor T5 may have a drain terminal that is coupled to the second source-drain terminal of transistor T2, a gate terminal that receives second emission control signal EM2, and a source terminal that is coupled to ground power supply terminal 302 via diode 304.

Transistor T3, capacitor C1, and transistor T6 may be coupled in series between the first source-drain terminal of drive transistor T2 and power supply terminal 308. Transistor T3 may have a first source-drain terminal that is coupled to the first source-drain terminal of transistor T2, a gate terminal that receives the second scan control signal SCAN2, and a second source-drain terminal that is coupled to the gate of transistor T2. Storage capacitor C1 may have a first terminal that is coupled to the gate of transistor T2 and a second terminal that is coupled to the source terminal of transistor T5. Transistor T6 may have a drain terminal that is coupled to the source terminal of transistor T5 (and to the p-type terminal of diode 304), a gate terminal that receives the second scan control signal SCAN2, and a source terminal that receives voltage Vini via terminal 308. Transistor T1 may have a drain terminal that is coupled to the second source-drain terminal of drive transistor T2, a gate terminal that receives first scan control signal SCAN1, and a source terminal that receives data line signal DL via terminal 310. Connected in this way, signal EM1 may be asserted to enable transistor T4; signal EM2 may be asserted to activate transistor T5; signal SCAN1 may be asserted to turn on transistor T1; and signal SCAN2 may be asserted to switch into use transistors T3 and T6.

Each display pixel such as display pixel 22 of FIG. 3 may be operated in at least three repeating phases—a reset/initialization phase, a data loading and threshold voltage compensation phase, and an emission phase. During reset, threshold voltage compensation, and data loading operations, the control circuitry of display pixel 22 is used to establish a control voltage on the gate of drive transistor T2 that is independent of the threshold voltage Vth of drive transistor T2, that is independent of the capacitance C_{OLED} of diode 304, and that is proportional to the magnitude of a data signal D that has been loaded into the display pixel from an associated data line 26 and terminal 310. During the subsequent emission phase, drive transistor T2 drives a corresponding current through light-emitting diode 304 so that an appropriate amount of light 306 is emitted by display pixel 22. An entire row of display pixels may be compensated and loaded with data at the same time and this process repeated for each row in the display so that all rows are compensated and loaded in this way for each frame of data or other suitable control schemes can be used for the display pixels of display 14.

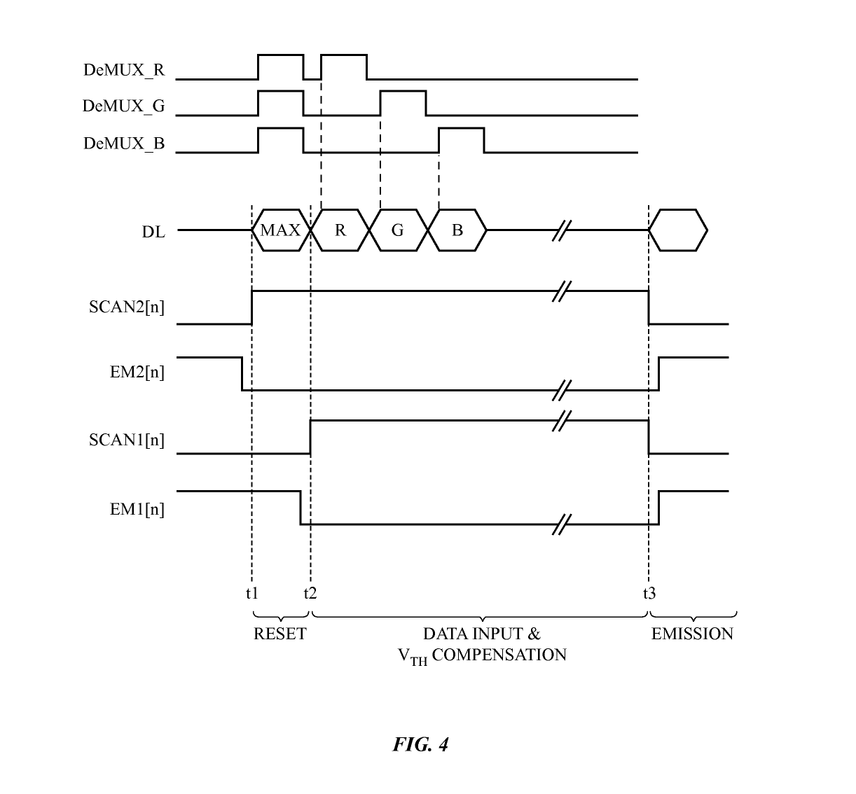

FIG. 4 is a timing diagram showing the states of signals that may be applied to each display pixel 22 of FIG. 3 during the three phases of operation per image frame: 1) reset (sometimes referred to as “initialization”), 2) data input and threshold voltage compensation, and 3) emission.

During reset (e.g., from time t1 to t2), control signal SCAN2 is driven high to turn on transistors T3 and T6, control signal EM2 is driven low to turn off transistor T5, control signal SCAN1 remains low to keep transistor T1 in the off state, and control signal EM1 remains high to keep transistor T4 in the on state. During this time, the demultiplexing control signals R, G, and B may all be asserted to pass a maximum reference voltage level onto the corresponding data lines RDL, GDL, and BDL (see, FIG. 2).

Under these conditions, transistor T4 will pull the first source-drain terminal of drive transistor T2 up to power supply voltage ELVDD. Transistor T3 will also pull the gate terminal of transistor T2 up to ELVDD. This in turn enables transistor T2 to pull its second source-drain terminal up to at least (ELVDD−Vth2), where Vth2 represents the threshold voltage of drive transistor T2. Transistor T5 is off, so organic light-emitting diode 304 is isolated from drive transistor T2 and does not emit light 306. To ensure that organic light-emitting diode 304 is turned off and does not emit light, initialization voltage Vini (sometimes referred to as a “suspension” voltage) is applied to the p-type terminal (or anode) of diode 304 to reverse bias diode 304. This reverse bias may be applied to diode 304 during the reset phase and the data loading and compensation phase.

After reset operations are complete, the data input and threshold voltage compensation operations are performed. During this time (e.g., from time t2 to t3), control signal SCAN1 may be driven high to turn on transistor T1, control signal EM1 may be driven low to turn off transistor T4 (while signal SCAN2 remains high and while signal EM2 remains low). At time t2, the demultiplexing control signals may be sequentially asserted to load red data signals, green data signals, and blue data signals into respective display pixels 22 via transistor T1. Under these conditions, transistor T1 will drive the second source-drain terminal of transistor T2 to data signal level Vdata while the first source-drain terminal and the gate terminal of transistor T2 are both pulled down to (Vdata+Vth2).

After data input and threshold voltage compensation operations, emission operations are performed. During emission operations, control signal SCAN2 is driven low to turn off transistors T3 and T6, control signal EM2 is driven high to turn on transistor T5, control signal SCAN1 is driven low to turn off transistor T1, and control signal EM1 is driven back high to activate transistor T4. With transistor T6 turned off, the p-type terminal of diode 304 is isolated from voltage Vini. With transistor T1 turned off, data terminal 310 is isolated from the drive transistor. Because transistors T4, T2, and T5 are all turned on, a current I_{OLED} may flow from power supply terminal 300 via these series connected transistors and diode 304 to power supply terminal 304, thereby causing diode 304 to produce a corresponding amount of light 306. This may result in a voltage drop V_{OLED} across diode 306.

Under these conditions, the first source-drain terminal of drive transistor T2 may be driven to ELVDD, and the source terminal of transistor T5 may be held at (V_{OLED}+ELVSS), which will also pull the second source-drain terminal of transistor T2 down to (V_{OLED}+ELVSS). At time 3, the voltage at the p-type terminal of diode 304 may therefore change from Vini to (V_{OLED}+ELVSS), which results in a net voltage change of (V_{OLED}+ELVSS−Vini). Since the voltage across capacitor C1 cannot change instantaneously, this voltage change at the second terminal of capacitor C1 will cause the first terminal of capacitor C1 to change from (Vdata+Vth2) to [(Vdata+Vth2)+(V_{OLED}+ELVSS−Vini)]. Since the first terminal of capacitor C1 is shorted to the gate terminal of drive transistor T2, the gate terminal of transistor T2 will therefore exhibit a voltage level of [(Vdata+Vth2)+(V_{OLED}+ELVSS−Vini)] during emission.

With these voltages established at the various terminals of drive transistor T2, the drive current I_{OLED} that flows through transistor T2 is given by I_{OLED}=k*(V_{GS}−Vth2)². Substituting V_{GS} with the difference between the voltage at the gate terminal of transistor T2 (which is equal to [(Vdata+Vth2)+(V_{OLED}+ELVSS−Vini)], as described above) and the voltage at the second source-drain terminal of transistor T2 (which is equal to [ELVSS-V_{OLED}], as described above), we obtain I_{OLED}=k*[Vdata−Vini]². As this equation demonstrates, the magnitude of drive current I_{OLED} is proportional to the magnitude of data signal Vdata and is independent of threshold voltage Vth2 and V_{OLED} (i.e., compensation operations have been successfully performed, so that light emission is neither affected by Vth variations nor by variations associated with diode 304). In other words, operating display pixel 22 in the way shown in FIG. 4 can help provide reduced sensitivity to both threshold voltage variations and reduced sensitivity to any parasitic capacitance C_{OLED} associated with diode 304.

Simulations have been performed to evaluate the operation of the circuit of FIG. 3. These simulations indicate that light output 306 of light-emitting diodes such as diode 304 of FIG. 3 will not be significantly affected by drive transistor threshold voltage hysteresis and response time for display 14 will therefore be satisfactory. The output magnitude of a white pixel (as one example) will be substantially the same regardless of whether the state of the pixel was black in the prior frame or was white in the prior frame. Moreover, the brightness of display pixel 22 can be dynamically controlled by adjusting Vini without increasing the required data range. The use of transistor T5 to isolate the anode of diode 304 and the use of transistor T6 to keep the anode of diode 304 initialized at suspension voltage Vini for the majority of the pixel operation helps to improve pixel response time and reduce lateral leakage.

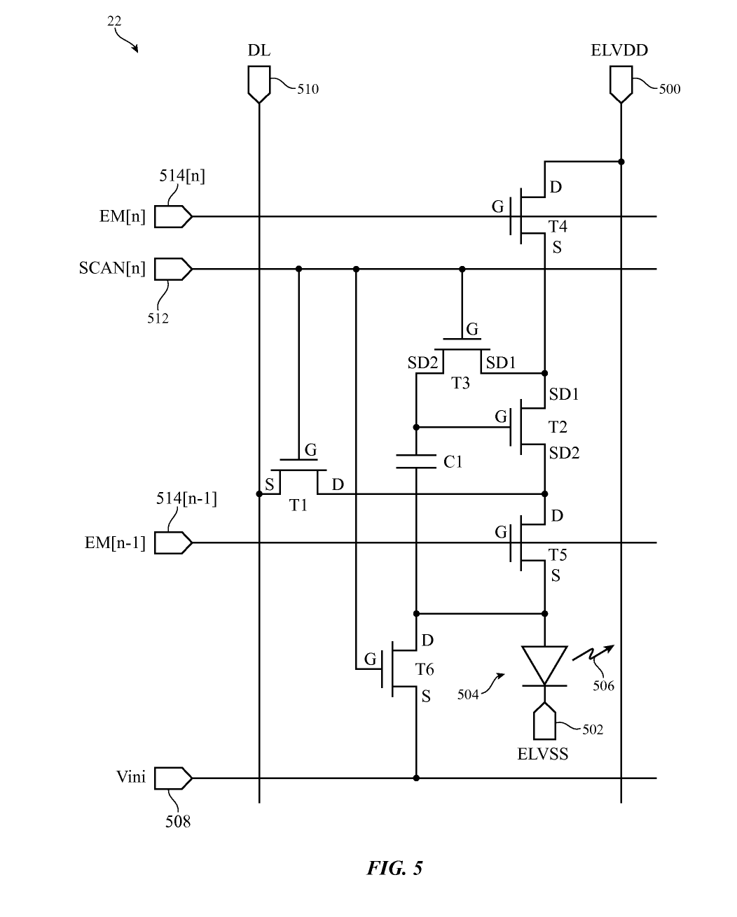

Another suitable arrangement of a display pixel 22 that can be used in display 14 of FIG. 1 is shown in FIG. 5. The pixel implementation of FIG. 5 requires only one scan control line and one emission control line per row. The emission control line can, however, be shared between adjacent rows. Similar to the embodiment of FIG. 3, display pixel 22 of FIG. 5 has a storage capacitor C1 and transistors such as n-channel transistors T1, T2, T2, T3, T4, T5, and T6. The transistors of pixel 22 may be thin-film transistors formed from a semiconductor such as polysilicon, indium gallium zinc oxide (IGZO), etc. If desired, any one or more of transistors T1-T6 may be p-channel thin-film transistors.

As shown in FIG. 5, display pixel 22 may include light-emitting diode 504. A positive power supply voltage ELVDD may be supplied to positive power supply terminal 500 and a ground power supply voltage ELVSS (e.g., 0 volts or other suitable voltage) may be supplied to ground power supply terminal 502. The state of drive transistor T2 controls the amount of current flowing from terminal 500 to terminal 502 through diode 504 and therefore the amount of emitted light 506 from display pixel 22. Diode 504 may have an associated parasitic capacitance C_{OLED} (not shown).

Terminal 508 is used to supply an initialization voltage Vini (e.g., a negative voltage such as −1 V or −2 V or other suitable voltage) to assist in turning off diode 504 when diode 504 is not in use. Control signals from display driver circuitry such as row driver circuitry 18 of FIG. 1 are supplied to control terminals such as terminals 512, 514[n], and 514[n−1]. Terminals 512 may serve as a scan control terminal that receives SCAN. Terminal 514[n] may serve as an emission control terminal that is associated with a particular row n, whereas terminal 514[n−1] may serve as an emission control terminal that is associated with an immediately preceding row (n−1). Emission control signals EM[n] and EM[n−1] may be supplied to terminals 514[n] and 514[n−1], respectively. A data input terminal such as data signal terminal 510 is coupled to a respective data line 26 of FIG. 1 for receiving image data for display pixel 22.

In the example of FIG. 5, transistors T4, T2, T5, and diode 504 may be coupled in series between power supply terminals 500 and 502. In particular, transistor T4 may have a drain terminal that is coupled to positive power supply terminal 500, a gate terminal that receives emission control signal EM[n], and a source terminal. Drive transistor T2 may have a first source-drain terminal SD1 that is coupled to the source terminal of transistor T4, a gate terminal, and a second source-drain terminal SD2. Transistor T5 may have a drain terminal that is coupled to the second source-drain terminal of transistor T2, a gate terminal that receives emission control signal EM[n−1], and a source terminal that is coupled to ground power supply terminal 502 via diode 504.

Transistor T3 may have a first source-drain terminal that is coupled to the first source-drain terminal of transistor T2, a gate terminal that receives scan control signal SCAN, and a second source-drain terminal that is coupled to the gate of transistor T2. Storage capacitor C1 may have a first terminal that is coupled to the gate of transistor T2 and a second terminal that is coupled to the source terminal of transistor T5. Transistor T6 may have a drain terminal that is coupled to the source terminal of transistor T5 (and to the anode of diode 504), a gate terminal that receives the scan control signal SCAN, and a source terminal that receives voltage Vini via terminal 508. Transistor T1 may have a drain terminal that is coupled to the second source-drain terminal of drive transistor T2, a gate terminal that receives scan control signal SCAN, and a source terminal that receives data line signal DL via terminal 510. Connected in this way, signal EM[n] may be asserted to enable transistor T4; signal EM[n−1] may be asserted to activate transistor T5; and signal SCAN may be asserted to turn on transistor T1, T3, and T6 simultaneously.

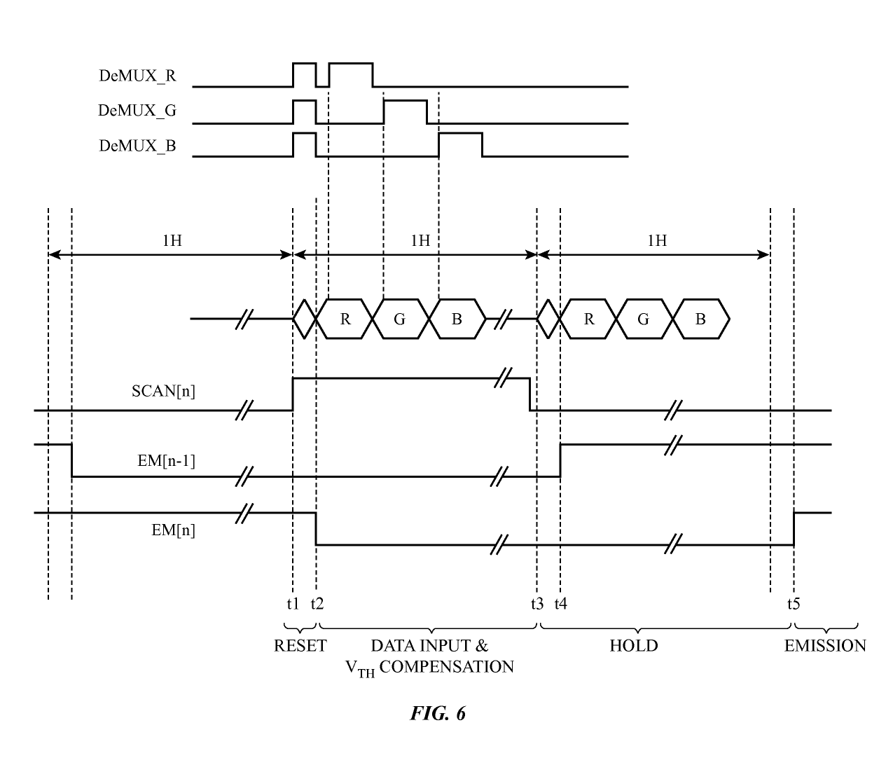

Each display pixel such as display pixel 22 of FIG. 5 may be operated in at least four repeating phases—a reset/initialization phase, a data loading and threshold voltage compensation phase, a holding phase, and an emission phase. FIG. 6 is a timing diagram showing the states of signals that may be applied to each display pixel 22 of FIG. 5 during the four phases of operation per image frame. As shown in FIG. 6, signal EM[n] may simply be a delayed version of EM[n−1] since EM[n−1] is effectively being borrowed from the immediately preceding row.

During reset (e.g., from time t1 to t2), control signal SCAN is driven high to turn on transistors T1, T3 and T6, control signal EM[n−1] remains low to keep transistor T5 in the off state, and control signal EM[n] remains high to keep transistor T4 in the on state. During this time, the demultiplexing control signals R, G, and B may all be asserted to pass a maximum reference voltage level onto the corresponding data lines RDL, GDL, and BDL (see, FIG. 2).

Transistor T5 is off, so organic light-emitting diode 504 is isolated from drive transistor T2 and does not emit light 506. To ensure that organic light-emitting diode 504 is turned off and does not emit light, initialization voltage Vini is applied to the anode of diode 504 to reverse bias diode 504. This reverse bias may be applied to diode 504 during the reset phase and the data loading and compensation phase.

After reset operations are complete, the data input and threshold voltage compensation operations are performed. During this time (e.g., from time t2 to t3), control signal SCAN may remain high to keep transistors T1, T3, and T6 in the on state, control signal EM[n−1] may remain low to keep transistor T5 in the off state, whereas control signal EM[n] may be driven low to deactivate transistor T4. At time t2, the demultiplexing control signals may be sequentially asserted to load red data signals, green data signals, and blue data signals into respective display pixels 22 via transistor T1. Under these conditions, transistor T1 will drive the second source-drain terminal of transistor T2 to data signal level Vdata while the first source-drain terminal and the gate terminal of transistor T2 are both pulled down to (Vdata+Vth2).

After data input and threshold voltage compensation operations, data may be held during a holding phase from time t3 to t5. In particular, control signal SCAN may be driven low at time t3 to turn off transistors T1, T3, and T6, and control signal EM[n−1] may be driven high at time t4 to turn on transistor T5.

At the end of the holding phase, emission operations are performed. During emission operations, control signal EM[n] may be driven high (i.e., at time t5) to turn on transistor T4. With transistor T6 turned off, the anode of diode 504 is isolated from voltage Vini. With transistor T1 turned off, data terminal 510 is isolated from the drive transistor T2. Because transistors T4, T2, and T5 are all turned on, a current I_{OLED} may flow from power supply terminal 500 via these series connected transistors and diode 504 to power supply terminal 504, thereby causing diode 504 to produce a corresponding amount of light 506. Similar to the pixel arrangement of FIG. 3, the magnitude of drive current I_{OLED} may be proportional to the magnitude of data signal Vdata but is independent of threshold voltage Vth2 and V_{OLED}. In other words, operating display pixel 22 in the way shown in FIG. 5 can help provide reduced sensitivity to both threshold voltage variations and reduced sensitivity to any parasitic capacitance C_{OLED} associated with diode 504.

Simulations have been performed to evaluate the operation of the circuit of FIG. 6. These simulations indicate that light output 506 of light-emitting diodes such as diode 504 of FIG. 5 will not be significantly affected by drive transistor threshold voltage hysteresis and response time for display 14 will therefore be satisfactory. The output magnitude of a white pixel (as one example) will be substantially the same regardless of whether the state of the pixel was black in the prior frame or was white in the prior frame. Moreover, the brightness of display pixel 22 can be dynamically controlled by adjusting Vini without increasing the required data range. The use of transistor T5 to isolate the anode of diode 504 and the use of transistor T6 to keep the anode of diode 504 initialized at suspension voltage Vini for the majority of the pixel operation helps to improve pixel response time and reduce lateral leakage.

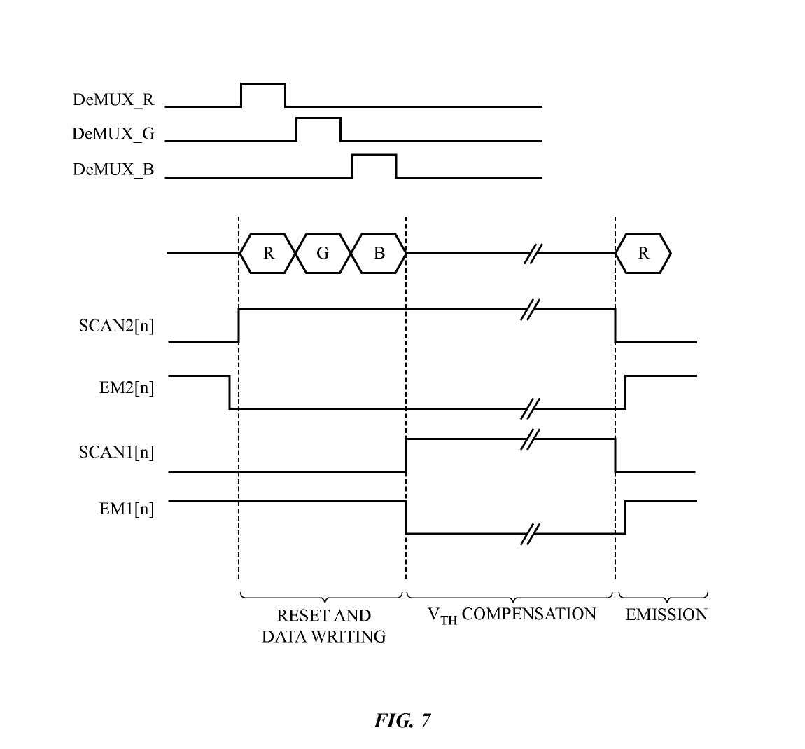

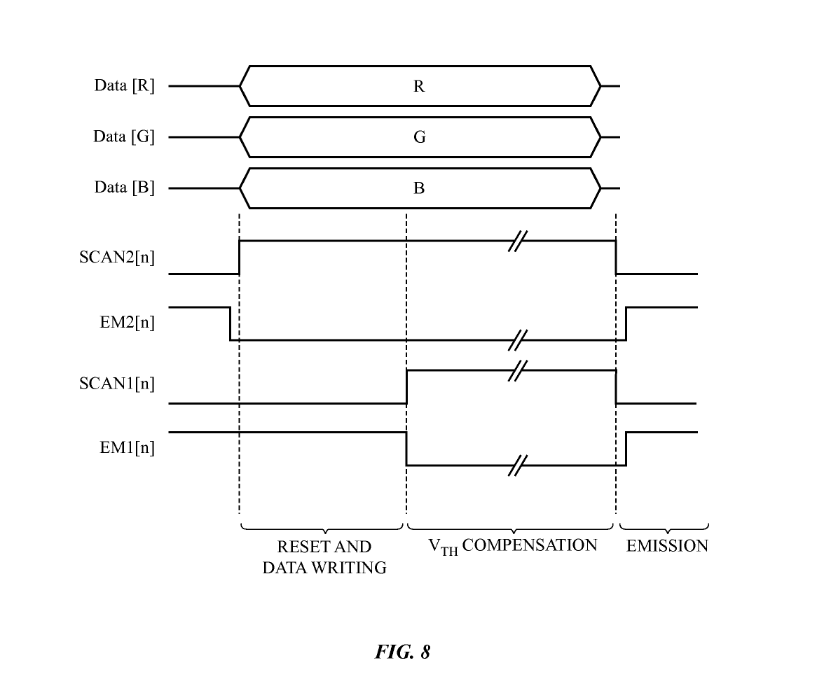

FIGS. 7 and 8 are timing diagrams showing the states of signals that may be applied to each display pixel 22 of FIG. 3 during three phases of operation per image frame: 1) reset and data writing (data input), 2) threshold voltage compensation, and 3) emission.

The arrangement of FIG. 7 uses a series data loading scheme. During data loading, demultiplexing control signals DeMUX are provided to demultiplexer 20 to demultiplex data signals from display driver circuit 16 into data signals on data lines DL for respective columns of red, green, and blue pixels.

During reset and data writing operations, transistors T2, T3, and T4 are used to set the voltage on gate G of transistor T2 while simultaneously writing data over data lines DL. Scan2 is asserted while SCAN1 is deasserted. Emission enable (control) signal EM2 is deasserted while emission enable (control) signal EM1 is asserted. Transistor T1 is off, so data writing and reset operations can be performed at the same time.

During Vth compensation operations, transistor T4 is turned off and transistor T1 is turned on. Signals SCAN2 and SCAN1 are asserted while emission signals EM1 and EM2 are deasserted. The voltage on gate G will become Vdata+Vth (of T2) and node A will be driven to Vini.

During emission operations, scan line signals SCAN1 and SCAN2 are deasserted, while emission enable signals EM1 and EM2 are asserted. The current through diode 304 Ioled will be given by the following equation: Ioled=k [Vdata−Vini]², which is independent of the threshold voltage Vth of transistor T2 as desired (i.e., circuit 22 has been compensated for variations in Vth).

The arrangement of FIG. 8 uses a parallel data loading scheme in which red, green, and blue data is loaded simultaneously without using demultiplexing signals DeMUX. With this approach, additional column drivers for data lines DL (sometimes referred to as source drivers or source line drivers) may be incorporated into driver circuitry 16, so that demultiplexing by circuitry 20 is not needed. During operation of display 14, red data R, green data G, and blue data B are written into the pixels of display 14 simultaneously on parallel data lines DL. The scan lines and emission control lines may be controlled in the same way that these lines are controlled using the serial data loading arrangement of FIG. 7 (as an example).

Transistor T6 of FIG. 3 may be used (e.g., in connection with the arrangements of FIGS. 7 and 8 or other suitable schemes) to set node A to initialization voltage Vini. It may be desirable to adjust black levels for display 14 by making adjustments to Vini using transistor T6. If desired, transistor T6 may be omitted to reduce the cost and complexity of display 14. In this type of arrangement, Ioled will no longer be k[Vdata−Vini]2, but rather will be k[Vdata−Vtholed), where Vtholed is the threshold voltage of diode 304. By using a diode manufacturing process that produces stable diodes 304 (i.e., diodes that do not exhibit excessive changes in Vtholed over time), transistor T6 may be satisfactorily eliminated without compromising display performance.

The foregoing is merely illustrative and various modifications can be made by those skilled in the art without departing from the scope and spirit of the described embodiments. The foregoing embodiments may be implemented individually or in any combination.

What is claimed is:

1. A display pixel, comprising:
an organic light-emitting diode;
a plurality of transistors one of which is a drive transistor that supplies a current to the organic light-emitting diode and that has a threshold voltage; and
a capacitor coupled to the drive transistor and the organic light-emitting diode, wherein the transistors are controlled using first, second, and third phases in each of a plurality of image frames, wherein the first phase is a reset and data writing phase in which data is loaded into the display pixel, the second phase is a threshold voltage compensation phase in which an initialization voltage is placed on a gate of the drive transistor, and the third phase is an emission phase in which the drive transistor supplies current to the organic light-emitting diode that is independent of the threshold voltage and that is responsive to the data that has been loaded into the display pixel.

2. The display pixel defined in claim 1 wherein the transistors include at least one transistor controlled by scan line signals and at least one transistor controlled by emission control signals.

3. The display pixel defined in claim 1 wherein the transistors include at least one transistor controlled by scan line signals and at least two transistors controlled by emission control signals.

4. The display pixel defined in claim 1 wherein the transistors include at least two transistors controlled by scan line signals and at least one transistor controlled by emission control signals.

5. The display pixel defined in claim 1 wherein the transistors include at least two transistors controlled by scan line signals and two transistors controlled by emission control signals.

6. The display pixel defined in claim 1 wherein the transistors comprise two transistors coupled in series with the drive transistor and the organic light-emitting diode and wherein the two transistors are controlled by emission control signals.

7. The display pixel defined in claim 6 wherein the transistors further comprise two transistors that are controlled by scan line signals.

8. The display pixel defined in claim 7 wherein the two transistors that are controlled by the scan line signals comprise:
a first transistor having a first gate coupled to a first scan line that provides a first of the scan line signals; and
a second transistor having a second gate coupled to a second scan line that provides a second of the scan line signals.

9. The display pixel defined in claim 8 further comprising a voltage initialization line that supplies the initialization voltage.

10. The display pixel defined in claim 9 the capacitor has a first terminal coupled to the gate of the drive transistor and has a second terminal.

11. The display pixel defined in claim 10 wherein the plurality of transistors includes a transistor having a first terminal coupled to the voltage initialization line and a second terminal coupled to the second terminal of the capacitor.

12. The display pixel defined in claim 11 wherein the transistor that has its first terminal coupled to the voltage initialization line has a gate that receives scan line signals.

13. The display pixel defined in claim 12 wherein the two transistors that are controlled by the emission control signals include a first emission transistor having a gate coupled to a first emission control line and a second emission transistor having a gate coupled to a second emission control line and wherein the first emission control line and the second emission control line carry emission control signals that are asserted during the emission phase.

14. The display pixel defined in claim 13 wherein the second transistor that is controlled by the scan line signals has a first terminal coupled to the first terminal of the capacitor and has a second terminal coupled to a node between the first emission transistor and the drive transistor.

15. The display pixel defined in claim 14 further comprising a data line, wherein the first transistor that is controlled by the scan line signals has a first terminal that is coupled to the data line and a second terminal that is coupled to a node between the drive transistor and the second emission transistor.

16. The display pixel defined in claim 15 wherein the transistor having the first terminal coupled to the voltage initialization line has a gate coupled to the second scan line.

17. A display, comprising:
an array of pixels each having:
an organic light-emitting diode;
a plurality of transistors one of which is a drive transistor that supplies a current to the organic light-emitting diode and that has a threshold voltage; and
a capacitor coupled to the drive transistor and the organic light-emitting diode, wherein the transistors are controlled using first, second, and third phases in each of a plurality of image frames, wherein the first phase is a reset and data writing phase in which data is loaded into the pixel, the second phase is a threshold voltage compensation phase in which an initialization voltage is placed on a gate of the drive transistor, and the third phase is an emission phase in which the drive transistor supplies current to the organic light-emitting diode that is independent of the threshold voltage and that is responsive to the data that has been loaded into the pixel.

18. The display defined in claim 17 wherein each pixel has five transistors including the drive transistor, two transistors controlled by scan line signals, and two transistors coupled in series with the drive transistor and controlled by emission control signals that are asserted during the emission phase.

19. A display, comprising:
an array of display pixels each having:
an organic light-emitting diode;
at least five transistors one of which is a drive transistor that supplies a current to the organic light-emitting diode and that has a threshold voltage; and
a capacitor coupled to the drive transistor and the organic light-emitting diode, wherein the transistors are controlled using first, second, and third phases in each of a plurality of image frames, wherein the first phase is a reset and data writing phase in which data is loaded into the display pixel, the second phase is a threshold voltage compensation phase in which an initialization voltage is placed on a gate of the drive transistor, and the third phase is an emission phase in which the drive transistor supplies current to the organic light-emitting diode that is independent of the threshold voltage and that is responsive to the data that has been loaded into the display pixel.

20. The display defined in claim 19 wherein each display pixel has six transistors including the drive transistor, three transistors controlled by scan line signals, and two transistors coupled in series with the drive transistor and controlled by emission control signals that are asserted during the emission phase.
